(19) United States
(12) Patent Application Publication
(10) Pub. No.: US 2009/0183476 A1
(43) Pub. Date: Jul. 23, 2009

(54) GAS PURIFYING APPARATUS AND SEMICONDUCTOR MANUFACTURING APPARATUS

(75) Inventors: Kazuya Dobashi, Yamanashi (JP); Teruyuki Hayashi, Yamanashi (JP); Akitake Tamura, Yamanashi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, TOKYO (JP)

(21) Appl. No.: 12/296,305

(22) PCT Filed: Apr. 2, 2007
(86) PCT No.: PCT/JP07/57390

§ 371 Date: Oct. 7, 2008

(30) Foreign Application Priority Data
Apr. 7, 2006 (JP) 2006-106664

(51) Int. Cl. B01D 50/00

(52) U.S. Cl. 55/487

(57) ABSTRACT

A gas purifying apparatus for removing particles from a gas. The gas purifying apparatus includes a first filter layer and a second filter layer, and the diameter of a fiber forming the first filter layer is larger than that of a fiber forming the second filter layer. A semiconductor manufacturing apparatus can use such a gas purifying apparatus.

### FIELD OF THE INVENTION

The present invention relates to a gas purifying apparatus for generating a clean gas by removing particles from the gas, and also relates to a semiconductor manufacturing apparatus using the gas purifying apparatus.

### BACKGROUND OF THE INVENTION

In a manufacturing process of a device including fine devices such as semiconductor devices (semiconductor chips), a production yield may be deteriorated if there exist particles (particulates) in a processing gas atmosphere. Thus, treating of a semiconductor wafer by a semiconductor manufacturing apparatus needs to be carried out in a clean gas atmosphere in which the number of particles is reduced.

For example, to reduce particles around or inside the semiconductor manufacturing apparatus (for example, a wafer loading unit and the like), there has been employed a method for supplying air through a filter such as a HEPA (High Efficiency Particulate Air) filter or a ULPA (Ultra Low Penetration Air) filter for capturing particles.

However, with the recent trend for miniaturization and high performance of semiconductor devices, contamination levels that have not been conventionally considered as an issue have arisen as problems, so that sufficient gas cleanness may not be obtained by using conventional filters.

For instance, in a highly miniaturized semiconductor device of high performance, fine particles, even a detection of which has been conventionally difficult, may cause problems. So far, there has been hardly any discussion on a technique for removing these fine particles (no greater than 50 nm, for example) in a processing gas atmosphere.

Accordingly, there have been raised concerns that fine particles may not be sufficiently removed with a conventional ULPA filter or the like, resulting in a reduction of production yield of the semiconductor manufacturing device.

[Patent Reference 1] Japanese Patent Laid-open Application No. H7-66165

### SUMMARY OF THE INVENTION

In view of the foregoing, the present invention provides a novel and useful gas purifying apparatus capable of solving the aforementioned problem and a semiconductor manufacturing apparatus using the gas purifying apparatus.

Specifically, the present invention provides a gas purifying apparatus for supplying a clean gas by removing fine particles therefrom and a semiconductor manufacturing apparatus using the gas purifying apparatus.

In accordance with a first aspect of the present invention, there is provided a gas purifying apparatus for eliminating particles from a gas, including a first filter layer and a second filter layer disposed upstream and downstream of a flow of the gas, respectively.

The first filter layer captures particles which are smaller than particles captured by the second filter layer.

In accordance with a second aspect of the present invention, there is provided a substrate processing apparatus including the gas purifying apparatus described above.

In accordance with a third aspect of the present invention, there is provided a gas purifying apparatus for eliminating particles from a gas, including a first filter layer and a second filter layer.

The first and second filter layers have different characteristics of particle capturing efficiency depending on a diameter variation of the particles.

In accordance with a fourth aspect of the present invention, there is provided a gas purifying apparatus for eliminating particles from a gas, including a first filter layer and a second filter layer.

The first and second filter layers have different particle capturing efficiencies for particles having a same diameter.

In accordance with the aspects of the present invention, it is possible to provide a gas purifying apparatus capable of providing a clean gas by removing particles from the gas, and a semiconductor manufacturing apparatus using the gas purifying apparatus.

### BRIEF DESCRIPTION OF THE DRAWINGS

FIG. 1 illustrates a gas purifying apparatus in accordance with a first embodiment of the present invention;

FIG. 2 shows a conventional gas purifying apparatus.

FIG. 3 provides a first chart showing an evaluation result of the gas purifying apparatus in FIG. 2.

FIG. 4 sets forth a second chart showing an evaluation result of the gas purifying apparatus in FIG. 2.

FIG. 5 depicts a third chart showing an evaluation result of the gas purifying apparatus in FIG. 2.

FIG. 6 presents a fourth chart showing an evaluation result of the gas purifying apparatus in FIG. 2.

FIG. 7 offers a fifth chart showing an evaluation result of the gas purifying apparatus in FIG. 2.

FIG. 8 describes a method for evaluating the gas purifying apparatus in FIG. 1.

FIG. 9 sets forth a chart showing an evaluation result of the gas purifying apparatus in FIG. 1.

FIG. 10 is a chart showing a capturing efficiency of a fiber filter.

FIG. 11 illustrates a modification of the gas purifying apparatus in FIG. 1.

FIG. 12 shows a semiconductor manufacturing apparatus in accordance with a second embodiment of the present invention.

### EXPLANATION OF REFERENCE NUMERALS

100, 200, 300: Gas purifying apparatus
100A, 200A: Primary side space
100B, 200B: Secondary side space
102, 202: Filter unit
101A, 102A, 104A, 202A: Filter layer
103, 203: Blower unit
103A, 203A: Blower
101B, 102B, 103B, 104B, 202B, 203B: Housing member
500: Semiconductor manufacturing apparatus
501: Housing member
502: Loading unit
503: Vertical furnace
504: substrate supporting unit

### DETAILED DESCRIPTION OF THE EMBODIMENTS

A gas purifying apparatus in accordance with an embodiment of the present invention is an apparatus for removing particles from a gas and includes a first filter layer and a second filter layer, wherein the diameter of a fiber forming the first filter layer is larger than the diameter of a fiber forming the second filter layer.

Conventionally, detecting fine particles themselves (no greater than 50 nm, for example) has been difficult, so that substantially no consideration has been made about a function of removing the fine particles from a gas atmosphere in a conventional gas purifying apparatus (filter). Accordingly, there has been raised a concern that the conventional gas purifying apparatus cannot sufficiently capture the fine particles whose diameters are no greater than 50 nm, so that a clean atmosphere can be contaminated by a gas supplied through the conventional gas purifying apparatus.

Meanwhile, the gas purifying apparatus in accordance with the embodiment of the present invention includes multiple filter layers (a first and a second filter layer) made up of fiber materials for capturing particles. Further, the diameter of the fiber forming the first filter layer is larger than that of the fiber forming the second filter layer. Accordingly, the gas purifying apparatus in accordance with the embodiment of the present invention is capable of eliminating the fine particles, which has been conventionally difficult to detect, from the gas.

Conventionally, it has been considered that the fiber diameter of a fiber filter should be small to capture fine particles. However, the present inventors have found that if the fiber diameter of the fiber filter is reduced beyond a certain limit, the efficiency for capturing the fine particles having a particle diameter equal to or less than a certain value (for example, no greater than 50 nm) would be rather deteriorated.

In this regard, the present inventor has found that, with a conventional filter, it is difficult to efficiently eliminate, from a gas, both the particles having a particle diameter of several hundred nanometers detectable by a conventional measuring method and at the same time the particles having a particle diameter no greater than about 50 nm which are hardly detectable by the conventional measuring method.

As a result of intensive research, the present inventor has discovered that particles can be efficiently removed by combining a filter layer made up of a large-diameter fiber for capturing fine particles no greater than a specific size (e.g., 50 nm) and a filter layer made up of a small-diameter fiber for capturing particles greater than the specific size.

Below, a configuration example of such inventive gas purifying apparatus and a particle elimination principle thereof will be explained with accompanying drawings.

### First Embodiment

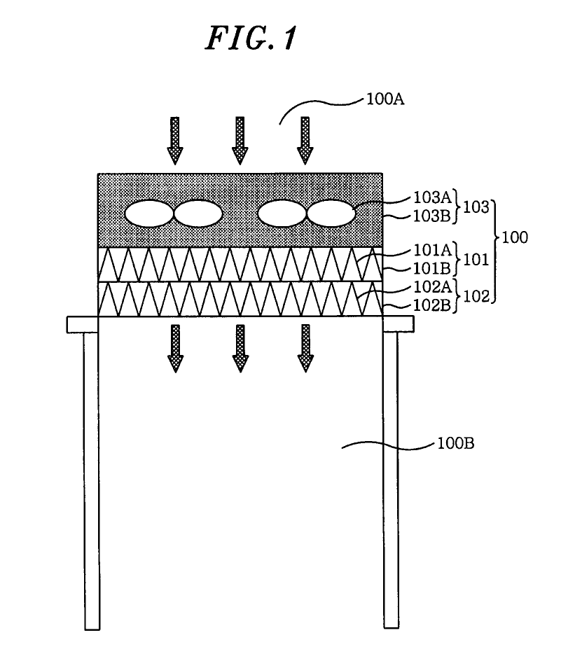

FIG. 1 presents a cross sectional view showing a gas purifying apparatus (filter) 100 in accordance with a first embodiment of the present invention. Referring to FIG. 1, the gas purifying apparatus 100 is provided between a primary side space 100A and a secondary side space 100B, and filters a gas (for example, air) supplied from the primary side space 100A while removing particles from the gas and supplies the particle-free gas to the secondary side space 100B.

Further, the gas purifying apparatus 100 has a laminated structure including a gas blower unit 103 for creating a gas flow, and a filter unit 101 and a filter unit 102 for removing particles from the gas supplied through the gas blower unit 103 which are laminated on top of each other.

The blower unit 103 has a blower (for example, a fan or the like) 103A accommodated in a housing member 103B. The filter unit 101 has a filter layer 101A accommodated in a housing member 101B, and the filter unit 102 has a filter layer 102A accommodated in a housing member 102B.

In this case, the filter layer 101A mainly captures particles having a small diameter (for example, 50 nm or less), while the filter layer 102A captures particles having a larger diameter than that captured by the filter layer 101A.

Since the gas purifying apparatus 100 in accordance with the present embodiment has the above-described arrangement, it can efficiently remove particles with a small particle diameter as well as particles with a relatively larger diameter from a gas, whereby a supply of a clean gas into the secondary side space 100B becomes feasible.

The filter layers 101A and 102A are made up of fiber filters, and the diameter of the fiber forming the filter layer 101A is larger than that of the fiber forming the filter layer 102A. The use of the filter layer 101A having the larger fiber diameter has made elimination of particles having smaller particle diameters possible. For example, the filter layer 102A corresponds to a typical ULPA filter.

Therefore, minute particles, which have been conventionally hard to remove, can be removed, so that a metal contamination of a target substrate (a wafer or the like) with fine metal or metal compound particles can be suppressed.

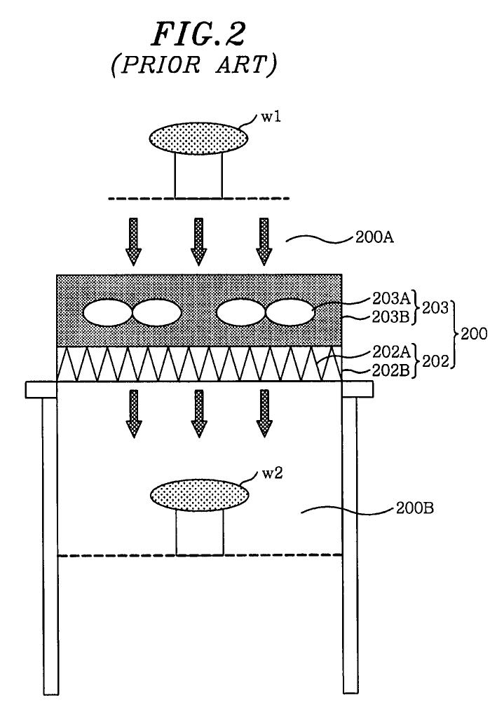

Now, to explain principles and effects of the gas purifying apparatus in accordance with the present embodiment, there will be first described experiments in which particles (metal contaminants) were removed by using a conventional gas purifying apparatus and analysis results thereof, with reference to FIGS. 2 to 7. FIG. 2 sets forth a schematic view of a conventional gas purifying apparatus 200 used in evaluating a particle elimination effect.

Referring to FIG. 2, the gas purifying apparatus 200 is disposed between a primary side space 200A and a secondary side space 200B, and serves to supply a gas (for example, air) from the primary side space 200A to the secondary side space 200B while removing particles from the gas by filtering it. The gas purifying apparatus 200 has a laminated structure including a blower unit 203 for generating a gas flow and a filter unit 202 for removing the particles from the gas blown from the gas blower unit 203.

The blower unit 203 includes a blower (for example, a fan or the like) 203A accommodated in a housing member 203B, and the filter unit 202 includes a filter layer 202A accommodated in a housing member 202B. The filter layer 202A is made up of a fiber filter layer (ULPA filter).

In the above-described configuration, a wafer w1 was disposed in the primary side space 200A and a wafer w2 was located in the secondary side space 200B, and particle movements and particle elimination were observed.

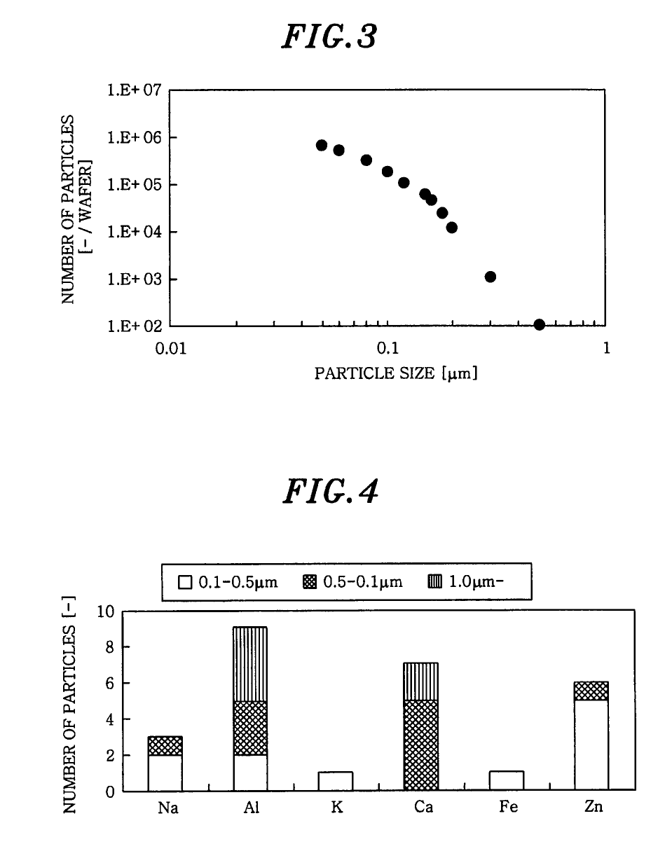

FIG. 3 presents a diagram showing a result of counting the number of particles present on the wafer w1 which was maintained in the primary side space (space before particle elimination) 200A for 10 minutes. FIG. 3 shows a tendency in which the number of particles increased with a decrease of particle diameter. To prevent contamination of a semiconductor device with particles, for example, it becomes important how to remove these fine particles which have been hardly removable. In view of the above, the present inventor carried out an analysis of movements of fine particles as follows.

FIG. 4 is a chart showing a result of analyzing diameters and components of particles, which were selected arbitrarily with a SEM (Scanning Electron Microscope), by using an EDX (Energy Dispersive X-ray) spectrometer. FIG. 4 only provides an analysis result of metal particles among various types of particles. In the analysis, particles were observed by using the SEM, and components (elements) of the selected particles were specified by analyzing them with the EDX. Further, for each element, the numbers of particles having particle sizes of 0.1 to 0.5 μm, 0.5 to 1.0 μm and more than 1.0 μm were measured.

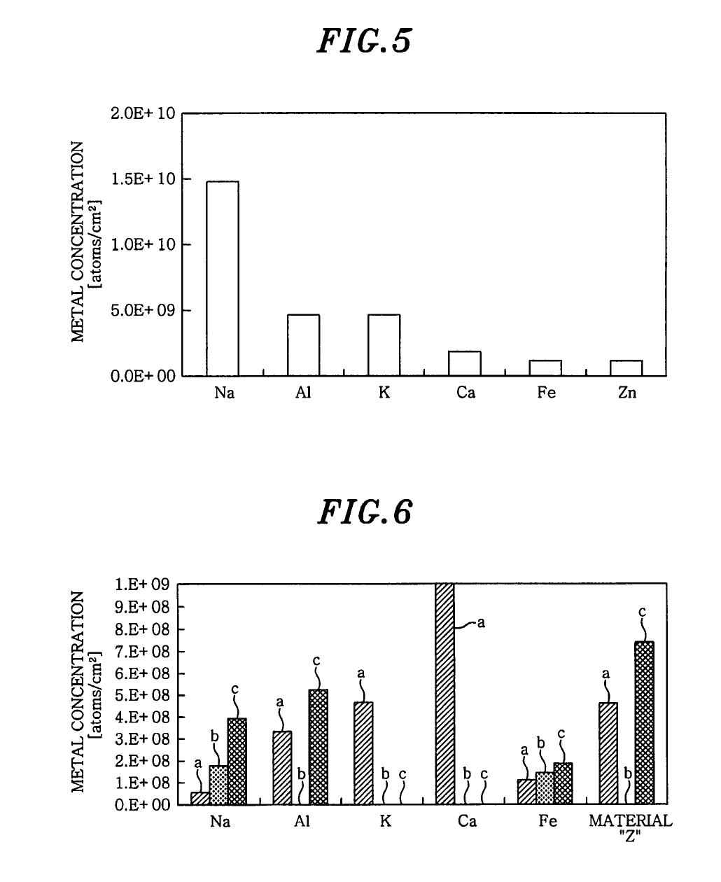

Further, FIG. 5 shows an analysis result of metal contamination on the surface of the silicon wafer w1 maintained in the primary space 200A shown in FIG. 2 for 10 minutes, wherein the analysis was carried out by using VPD ICP-MS (Vapor Phase Decomposition and Inductively Coupled Plasma Mass Spectrometry).

As can be seen from FIGS. 4 and 5, the analysis result in FIG. 4 and the analysis result of FIG. 5 are not necessarily coincident. For example, the analysis results in FIGS. 4 and 5 will be compared with reference to Na. Though the number of Na particles was smaller than those of Al and Ca as can be seen from FIG. 4, the level of Na contamination was found to be highest from the analysis in FIG. 5.

In view of the analysis results in FIGS. 4 and 5, the Na contamination of the wafer surface, for example, is considered to be due to particles having a size no greater than 0.1 nm (100 nm) which were not detected by the analysis in FIG. 4. That is, metal contamination (for example, Na contamination or the like) is considered to be largely affected by fine particles that were difficult to detect with the current technology.

Moreover, Table 1 provided below shows an increment of the number of particles of the wafer w2 kept in the secondary side space 200B in FIG. 2 for 60 hours. In Table 1, an increment of particles is provided for each of cases that particle sizes were 0.05 to 0.06 μm, 0.06 to 0.08 μm, 0.08 to 0.10 μm, 0.10 to 0.12 μm, 0.12 to 0.15 μm and more than 0.15, respectively.

TABLE 1

| | Particle Size(μm) | | | | | | |
|---|---|---|---|---|---|---|---|
| | 0.05- | 0.06- | 0.08- | 0.10- | 0.12- | | |
| | 0.06 | 0.08 | 0.10 | 0.12 | 0.15 | 0.15~ | Total |
| ΔN | 13 | 0 | 5 | 0 | 0 | 0 | 18 |

From the Table 1 showing the increment of 13 for the particles with sizes of 0.05 to 0.06 μm and the increment of 5 for particles with sizes of 0.08 to 0.10, it is proved that there were particles that penetrated the gas purifying apparatus.

Further, FIG. 6 provides an analysis result of metal contamination on the surface of the wafer w2, wherein the analysis was conducted by using VDP ICP-MS. Here, penetration of metal elements from the primary side space 200A into the secondary side space 200B is evaluated.

Further, as for a wafer used for this evaluation, metals on the surface thereof were removed in advance to the extent that metal concentration on the wafer surface did not exceed a specific level (for example, 2×10⁸ atoms/cm² or less for Na, 3×10⁸ atoms/cm² or less for Al). The number of particles detected on the surface of the wafer after such metal elimination process was set as a reference value for detection results in FIG. 6.

Moreover, material “Z” in FIG. 6 was found to have a peak value when m/z=64 by using ICP-MS, whereby it was interpreted that Zn or an S compound such as S₂, SO₂ or the like had been detected. Accordingly, quantitative analysis was carried out in this evaluation by using a calibration curve of Zn. Further, for each of the elements in FIG. 6, “a” represents a quantitative lower limit, “b” represents a reference value (a value detected at the moment the wafer was introduced to be left exposed in the secondary side space 200A after the metal elimination from the wafer surface had been conducted), and “c” denotes a measurement value obtained after the wafer had been left in the space 200A for 60 hours.

As observed from FIG. 6, contamination levels of, e.g., Na, Al, Fe, material Z increased on the surface of the wafer w2 kept in the secondary side space 200B for 60 hours. This result clearly shows that the gas purifying apparatus 200 was incapable of removing metal contaminants (particles) sufficiently.

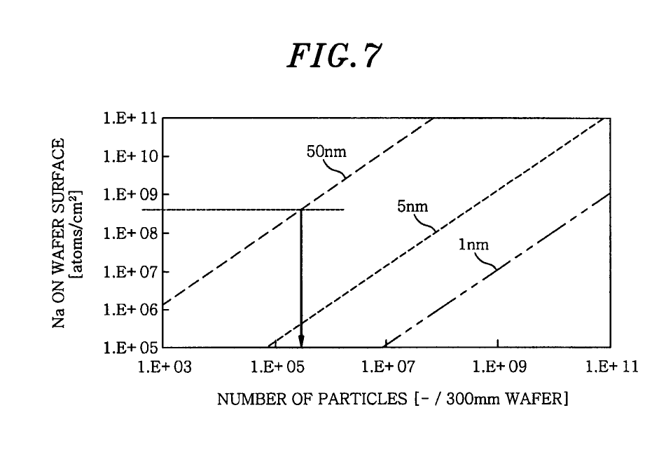

Then, the following analysis was carried out for particles that were believed to be the cause of the metal contamination by taking Na as an example. FIG. 7 shows a correlation between a Na metal contamination amount on the wafer surface and the number of particles containing Na estimated from the contamination amount. When carrying the estimation, it was assumed that the particles serving as the source of Na contamination were in the form of NaCl, and the particles have a spherical shape. Specifically, FIG. 7 provides the number of particles that were thought to be present on the wafer surface for each of cases that the particle sizes were 50 nm, 5 nm, and 1 nm, respectively.

Referring to FIG. 7, in case the particle size of particles (made up of NaCl) was 50 nm, for example, the number of particles corresponding to the detection amount of Na shown in FIG. 6 was about 3×10⁵ for the wafer (300 mm) Meanwhile, the increment of the number of particles on the wafer surface 18, as described before, when the particle size was in the range of about 0.05 μm to 0.1 μm (50 nm to 100 nm).

In view of the above result, most of the particles that penetrated the gas purifying apparatus (conventional ULPA filter) 100 are deemed to be those having a diameter of about 50 nm or less. Conventionally, detection of the particles having the diameter of about, e.g., 50 nm or less has been difficult, so that there has been hardly conducted a research upon their elimination method or relevance to metal contamination.

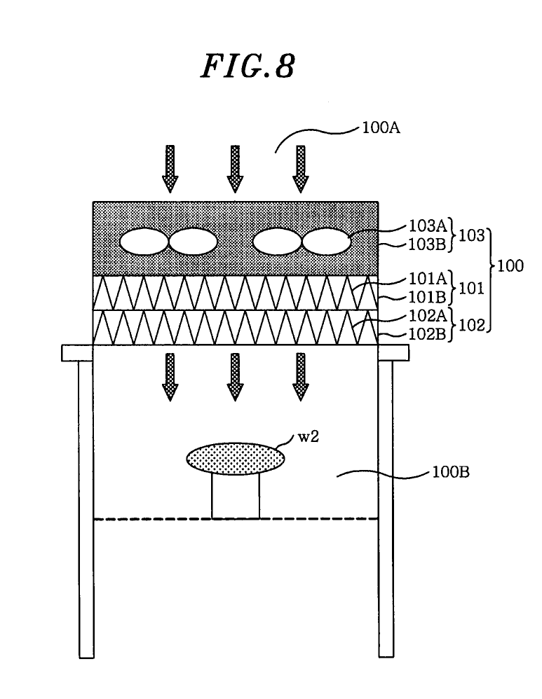

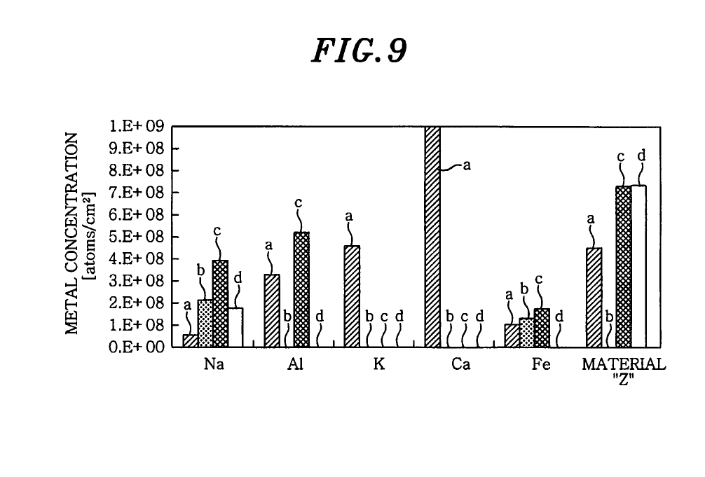

Now, evaluation for the elimination of these fine particles will be described with reference to FIGS. 8 to 10.

FIG. 8 schematically illustrates a method for evaluating the elimination of particles (metal contaminants) which was performed by using the gas purifying apparatus 100 shown in FIG. 1. Same parts in FIGS. 1 and 8 are assigned same reference numerals, and redundant description thereof will be omitted. Further, in the first evaluation, the filter layer 101A and the filter layer 102A were set to be made up of a same material featuring a same density (that is, they were formed as dual ULPA filters).

Specifically, employed as the filter layers 101A and 102A were ULPA filters produced by Daikin Industries (air filters having a particle capturing efficiency higher than or equal to 99.9995% for a particle having a diameter of 0.15 μm at a wind velocity of 0.5 m/sec, and also featuring an initial pressure loss less than or equal to 245 Pa).

Referring to FIG. 8, a silicon wafer w2 (300 mm) was disposed in the secondary side space 100B of the gas purifying apparatus 100 and had been kept therein for 60 hours. Then, an increase of particles and metal contamination on the surface of the wafer were evaluated.

Table 2 provided below shows an increment of particles on the wafer w2, an increment of particles being for each of cases that particle diameters were 0.05 to 0.06 μm, 0.06 to 0.08 μm, 0.08 to 0.10 μm, 0.10 to 0.12 μm, 0.12 to 0.15 μm and more than 0.15 μm, respectively. Further, in the Table 2, “single” refers to the results estimated by the evaluation method described in FIG. 2, while “double” refers to results estimated by the evaluation method described in FIG. 8.

TABLE 2

| | Particle Size(μm) | | | | | | |
|---|---|---|---|---|---|---|---|
| | 0.05- | 0.06- | 0.08- | 0.10- | 0.12- | | |
| | 0.06 | 0.08 | 0.10 | 0.12 | 0.15 | 0.15~ | Total |
| ΔN | 13 | 0 | 5 | 0 | 0 | 0 | 18 |
| Single | | | | | | | |
| ULPA | | | | | | | |
| filter | | | | | | | |
| ΔN | 2 | 0 | 0 | 0 | 0 | 0 | 2 |
| Double | | | | | | | |
| ULPA | | | | | | | |
| filter | | | | | | | |

As can be seen from the Table 2, when the double filter layers were used, the number of particles passing through the filters decreased.

FIG. 9 provides an analysis result of metal contamination of the wafer w2, which was carried out by using VPD ICP-MS as in the analysis of FIG. 6. FIG. 9 shows evaluation results (detection results d) of the wafer w2 in addition to the results shown in FIG. 6. Here, same conceptions will be assigned same notations, and redundant description thereof will be omitted. From FIG. 9, it is found that detected amounts of Na, Al and Fe on the wafer surface decreased when the double ULPA filters were used.

Moreover, as described with reference to FIGS. 4 and 5, and FIGS. 6 and 7, since the particles that caused Na contamination are deemed to have particularly smaller diameters than those of the particles that caused other types of metal contaminations, it is preferable to remove Na-containing fine particles having a diameter no greater than about 50 nm to reduce the Na contamination.

For this reason, the gas purifying apparatus 100 described in FIG. 1 was configured to have, in addition to the filter layer 102A corresponding to a typical ULPA filter, the filter layer 101A made up of a fiber having a larger diameter than that of a fiber forming the filter layer 102A.

Therefore, with the gas purifying apparatus 100, it became possible to efficiently remove the Na-containing particles having a diameter of no greater than about 50 μm which had been hard to remove conventionally. The reason therefor will be explained below.

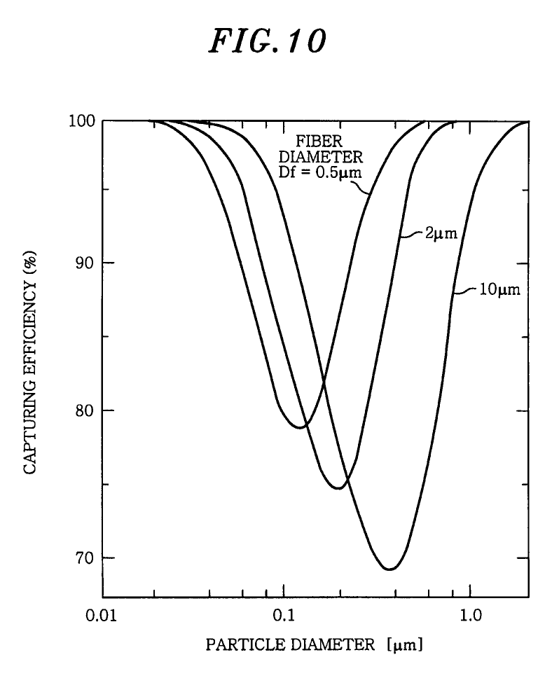

FIG. 10 is a graph showing particle capturing efficiencies of a fiber filter for removing particles for different fiber diameters df (described on page 178 of a book titled “Aerosol Technology” written by William C. Hinds and published by Inoueshoin). Specifically, FIG. 10 shows the particle capturing efficiencies when the fiber diameters are set to be 0.5 μm, 2 μm, and 10 μm, respectively. The horizontal axis of the graph represents a particle diameter, while the vertical axis thereof represents a particle capturing efficiency.

Referring to FIG. 10, it has been believed in general that a capturing efficiency of minute particles improves as the fiber diameter is reduced. For example, if the fiber diameter is decreased, a particle diameter indicating a minimum particle capturing efficiency (a minimum point of the graph) decreases, so that a minimum particle capturing efficiency is enhanced (described on page 179 of “Aerosol Technology” written by William C. Hinds and published by Inoueshoin). This implies that the position of the minimum point indicating the “minimum particle capturing efficiency” moves to the left in the graph by decreasing the fiber diameter, and the minimum point increases (which means an improvement of the particle capturing efficiency).

Referring to FIG. 10, however, it can be seen that, in the left part of the minimum particle capturing efficiency (minimum point) of each fiber diameter (the side to which the particle diameter decreases), the particle capturing efficiency tends to increase with increase of the fiber diameter. This tendency is deemed to imply that it is more effective to use a filter with a larger fiber diameter when capturing minute particles having a diameter no greater than about 100 nm (0.1 μm).

The above effect shows that raising collision probability of the particles with the filter material is effective to capture the fine particles and, thus, making the fiber diameter large is preferable therefor.

That is, though it is more effective to use a filter made up of a fiber having a smaller diameter in case of capturing particles having a diameter equal to or more than a specific value (about 100 nm or greater), it is expected to be more advantageous to use a filter made up of a fiber having a larger diameter when capturing particles equal to or less than a certain value (about 50 nm or less).

For example, in case of particles causing the Na contamination, diameters of the particles that contribute to the Na contamination are deemed to be almost no greater than about 50 nm, as described in FIGS. 6 and 7. In this case, it is effective to use a filter layer made up of a fiber having a larger diameter to suppress metal contamination (Na contamination). Meanwhile, as for particles having a particle diameter of no less than about 100 nm, it is preferable to use a filter layer made up of a fiber having a small diameter as conventionally.

Thus, in the gas purifying apparatus 100 shown in FIG. 1, by combining the filters having different fiber diameters, it is possible to remove the minute particles with diameters no greater than 50 nm as well as the particles with diameters of several hundred nanometers effectively.

In other words, the above-described gas purifying apparatus 100 uses a combination of filter layers having different particle capturing efficiencies (that is, filter layers having different particle capturing efficiency characteristics depending on a variation of a particle diameter or filter layers having different particle capturing efficiencies for particles of same diameter), whereby it can eliminate the minute particles having a diameter no greater than about 50 nm as well as the particles having a diameter of several hundred nanometers.

Further, by considering the minimum particle capturing efficiency of the filter (the minimum value of the graph) shown in FIG. 10, it can be seen that a filter having a high minimum particle capturing efficiency is suitable for capturing particles having a diameter no smaller than a specific value (e.g., about 100 nm), while a filter having a low particle capturing efficiency is adequate for capturing particles having a diameter no greater than a certain value (e.g., about 50 nm). That is, by combining (laminating) the filters having different minimum particle capturing efficiencies, it becomes possible to eliminate the minute particles no greater than about 50 nm as well as the particles of several hundred nanometers efficiently.

Moreover, as can be seen from the experimental results shown in FIG. 9, it is also possible to reduce the number of particles no greater than about 50 nm passed through the conventional gas purifying apparatus by laminating ULPA filters. In such case, the filter layers 101A and 102A may be formed by laminating filters (specified as JIS Z 8122) each having a particle capturing efficiency higher than or equal to 99.9995% for a particle having a diameter of 0.15 μm at a regularly standardized airflow and also featuring an initial pressure loss less than or equal to 245 Pa may be used.

Moreover, in the above-described gas purifying apparatus 100, a pressure loss in the filter layer 101A is smaller than a pressure loss in the filter layer 102A, so that a total pressure loss becomes smaller than that of the case where the filters with a small fiber diameter (filter layers 102A) are laminated.

Further, among the filters 101A and 102A, it is preferable to dispose the filter layer 101A with the larger fiber diameter upstream of a gas flow. It is because this arrangement allows particles, which might have escaped from the filter 101A after being captured and cohered, to be recaptured by the filter layer 102A.

Further, to capture the particles efficiently by the filter layers 101A and 102A, it is also preferable to set the filter layer 101A and 102A to have different porosities.

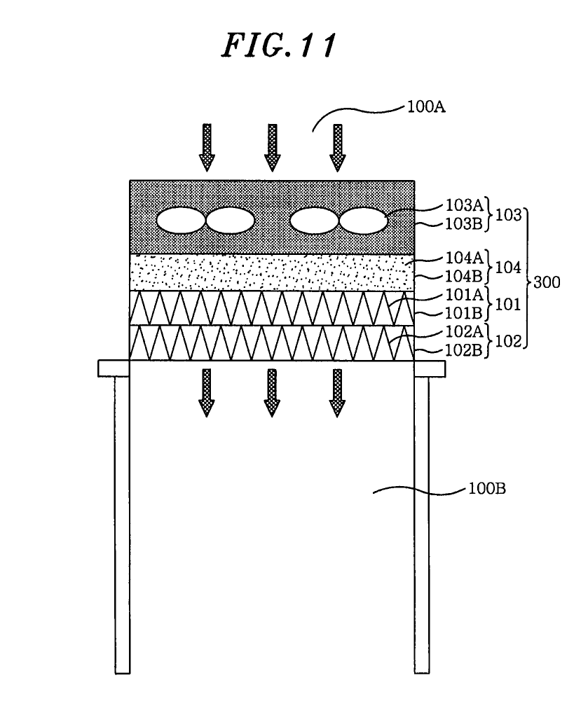

In addition, the gas purifying apparatus 100 may further include a filtration layer for removing organic materials or ions. FIG. 11 is a modification of the gas purifying apparatus 100 shown in FIG. 1, wherein parts identical with those described in FIG. 1 will be assigned same reference numerals, while omitting redundant description thereof.

Referring to FIG. 11, a gas purifying apparatus 300 includes a filtration layer 104 for removing organic materials or ions in addition to the configuration of the gas purifying apparatus shown in FIG. 1. The filtration layer 104 has a filter layer 104A embedded in a housing member 104B. By adding such filtration layer for removing the organic materials or ions, it becomes possible to suppress contamination by the organic materials or ions as well as preventing contamination by metals.

Moreover, the type of the filter layers is not limited to a fiber filter. For example, the filter layer disposed upstream of the gas flow may be formed of a material selected from a group including glass, metal, resin, ceramics and activate carbon. Further, the filter layer disposed downstream of the gas flow may be made up of, for example, any one of either glass or resin. In addition, since the filter on the upstream side captures particles mainly containing metals (Na and the like) and having a diameter no greater than about 50 nm, the filter layer provided on the downstream side may be preferably formed of a non-metal material. Further, the structure of each of the filter layers on the upstream and downstream sides is not limited to a single-layer structure, but may be a multi-layered structure.

### Second Embodiment

A substrate processing apparatus can be provided with the gas purifying apparatus 100 (or the gas purifying apparatus 300) in accordance with the first embodiment of the present invention.

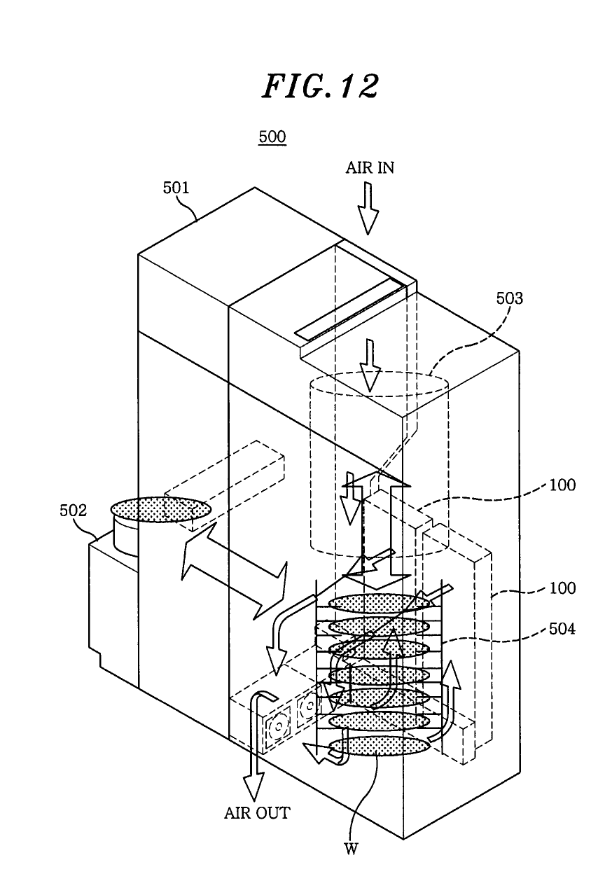

FIG. 12 schematically illustrates a configuration of a semiconductor manufacturing apparatus 500, which is an example of the substrate processing apparatus including the gas purifying apparatus 100 in FIG. 1. The semiconductor manufacturing apparatus 500 is a so-called CVD (Chemical Vapor Deposition) apparatus having a vertical furnace.

Referring to FIG. 12, the semiconductor manufacturing apparatus 500 includes a housing 501, and a vertical furnace 503 for performing a film formation by CVD therein is disposed inside the housing 501. Also installed in the housing 501 is a substrate supporting unit 504 which serves to transfer a plurality of wafers into the vertical furnace 503 while maintaining the wafers therein.

The substrate supporting unit 504 is configured to be inserted into the vertical furnace by a driving mechanism (not shown), while maintaining therein the wafers. Further, the wafers (target substrates to be processed) are loaded into the inside of the housing 501 from a loading unit 502.

In the above-mentioned configuration, the gas purifying apparatus 100 in accordance with the first embodiment is installed inside the housing 501, and a gas (air) sucked from the vicinity of the housing 501 is supplied into the inside of the housing 501 after particles (substances that would become a contamination source) are removed from the gas (air) by the gas purifying apparatus 100.

The inside of the housing 501 is an area in which a wafer before a film formation (before being loaded into the vertical furnace) or a wafer after the film formation (unloaded from the vertical furnace) is treated, so that it is preferable to maintain the atmosphere inside the housing 501 to be free of particles or contaminants. In the semiconductor manufacturing apparatus in accordance with the present embodiment, a clean gas passing through the gas purifying apparatus is supplied into such wafer handling area. Thus, a wafer contamination level inside the housing 501 is kept low, so that the yield of the semiconductor manufacturing apparatus 500 improves.

Further, a substrate processing apparatus employing the gas purifying apparatus 100 is not limited to the above-mentioned example. For example, the gas purifying apparatus can also be applied to various types of semiconductor manufacturing apparatuses such as a single-sheet type film forming or etching apparatus which treats wafers sheet-by-sheet, a coater/developer, and the like. Moreover, in addition to the semiconductor manufacturing apparatus, the substrate processing apparatus may be, for example, a substrate storage apparatus, a substrate transfer apparatus, or the like. Moreover, the gas purifying apparatus in accordance with the present invention can also be used for the control of the atmosphere inside a clean room.

While the invention has been shown and described with reference to the embodiments, it will be understood by those skilled in the art that various changes and modifications may be made without departing from the scope of the invention as defined in the following claims.

### INDUSTRIAL APPLICABILITY

In accordance with the present invention, it is possible to provide a gas purifying apparatus for supplying a clean gas by removing fine particles therefrom and, also, to provide a semiconductor manufacturing apparatus using the gas purifying apparatus.

The present international application claims priority to Japanese Patent Application No. 2006-106664, field on Apr. 7, 2006, the entire contents of which are incorporated herein by reference.

1: A gas purifying apparatus for removing particles from a gas, comprising:
a first filter layer and a second filter layer disposed upstream and downstream of a flow of the gas, respectively,
wherein the first filter layer captures particles which are smaller than particles captured by the second filter layer.

2: The gas purifying apparatus of claim 1, wherein the diameter of a fiber forming the first filter layer is larger than the diameter of a fiber forming the second filter layer.

3: The gas purifying apparatus of claim 2, wherein the particles have diameters no greater than about 50 nm and contain metal.

4: The gas purifying apparatus of claim 2, wherein a pressure loss in the first filter layer is smaller than a pressure loss in the second filter layer.

5: The gas purifying apparatus of claim 1, wherein the first filter layer is made up of a single layer or plural layers.

6: The gas purifying apparatus of claim 1, wherein a material forming the first filter layer is selected from a group including metal, resin, ceramics and activated carbon, and a material forming the second filter layer is glass or resin.

7: The gas purifying apparatus of claim 1, further comprising a filtration layer for eliminating an organic material or an ion from the gas.

8. (canceled)

9: A gas purifying apparatus for eliminating particles from a gas, comprising:
a first filter layer; and
a second filter layer,
wherein the first and second filter layers have different characteristics of particle capturing efficiency depending on a diameter variation of the particles.

10: A gas purifying apparatus for eliminating particles from a gas, comprising:
a first filter layer; and
a second filter layer,
wherein the first and second filter layers have different particle capturing efficiencies for particles having a same diameter.
